(19) United States
(12) Patent Application Publication
(10) Pub. No.: US 2023/0039193 A1
(43) Pub. Date: Feb. 9, 2023

(54) METHOD FOR CONTROLLING A MATRIX DETECTOR, AND MATRIX DETECTOR

(71) Applicant: ISORG, Limoges CEDEX 3 (FR)

(72) Inventor: David BLANCHON, GRENOBLE CEDEX 09 (FR)

(21) Appl. No.: 17/787,417

(22) PCT Filed: Dec. 18, 2020
(86) PCT No.: PCT/EP2020/086968

§ 371 Date: Jun. 20, 2022

(30) Foreign Application Priority Data
Dec. 20, 2019 (FR) FR1915374

(51) Int. Cl. G06F 3/041; G06F 3/044

(52) U.S. Cl. CPC G06F 3/0416; G06F 3/044

(57) ABSTRACT

A method for controlling a matrix detector, where the detector includes a touch surface, a matrix of imaging pixels arranged in rows and in columns, and an illuminating surface. Each of the pixels has a transistor and a photodiode, where the pixels of at least one row may be activated or deactivated by an addressing device. The pixels of a same column are connected to a charge integrator capable of being powered on to read the content of a pixel when the latter is activated by the addressing device. The matrix control method includes the steps of: as long as a contact has not been detected by the touch surface, controlling the detector in a mode called standby, the standby mode periodically comprising an activation of all the pixels of the matrix detector during a first period of duration by the addressing device, and a deactivation by the addressing device of all the pixels during a second period of duration; and on detection of the contact by the touch surface, controlling the detector in a mode called normal, the normal mode comprising the sequential activation of the pixels row by row, and the reading of the pixel activated in each column by the corresponding charge integrator, by lighting the illuminating surface.

### FIELD

The invention relates to a matrix detector control method, to a matrix detector, and to a biometric pattern recognition system comprising such a matrix detector. The invention may be applied in particular to the recognition of biometric patterns (for example, fingerprints, or venous system), or also to the digitizing of documents, at any location of the detector.

### BACKGROUND

The matrix detectors used in so-called TFT (thin film transistors) panels are, in known fashion, formed of a plurality of pixels, arranged in rows and in columns, as illustrated in FIG. 1. Each pixel PI is formed of a photodiode PH coupled to the source of a thin film transistor TR. Each photodiode is transferred onto the TFT panel, generates charges proportionally to the received light energy, and stores them in its capacitive element. A luminous surface is arranged under the TFT panel. Thus, when the user places their finger on the detector, the luminous surface illuminates the TFT panel from underneath, and an image of the fingerprint may be taken.

Pixels PI are arranged on a same row when they are connected by their gate to a same gate line LI. Pixels PI are arranged on a same column when they are connected by their drain to a same data bus CL.

Gate lines LI are connected to an addressing device DA. The addressing device generates a voltage that may have a low level, or a high level. The low level corresponds to a voltage lower than the gate voltage of the transistors, and the high level corresponds to a voltage greater than or equal to the gate voltage of the transistors.

When a gate line LI is at the low level, the transistors in the row are off, and each photodiode PH in the row generates charges proportionally to the received light energy, and stores them in its capacitive element. When gate line LI switches to the low level, the transistors in the row turn on, and the charges are transferred along data column CL, to be read by a charge integrator IC.

The row addressing is sequential, so that the integration of the charges is performed row after row. Thus, once at least a portion of the matrix detector has been addressed (for example, the finger contact area), an image of the pattern may be generated.

In known fashion, the application of a reverse bias voltage (negative voltage VBIAS applied to the anode, and positive to the cathode), generated by voltage source ST enables to considerably improve the response time of the photodiodes. Indeed, the bias voltage adds to the intrinsic voltage of the junction between the N-type region and the P-type region of the photodiode, which widens the depletion region (also called ZCE) of the photodiode. A voltage source is thus connected to the anode of each photodiode, to apply the bias voltage. More precisely, a bus BU is connected between voltage source ST and each of columns CL.

In portable applications, the application, permanently, of a photodiode bias voltage is however not desirable. Indeed, the generation of a constant voltage (usually −6 V), with currents of a few milliamperes flowing through the matrix detector, alters the durability of the battery. Further, in the context of a fingerprint recognition use for a cell phone, it is not necessary to activate the fingerprint recognition function permanently, but only when the user touches the screen.

A “naïve” solution thus comprises only biasing the photodiodes at determined times, for example, when the user places their finger on the detector. Such a solution is not compatible with all types of photodiodes, particularly organic or amorphous silicon photodiodes. Indeed, amorphous silicon (a-Si) or organic photodiodes, transferred on a TFT panel, exhibit a lag, due to the electron/hole pair trapping/detrapping phenomenon. Thus, when the photodiode has been completely de-biased, several seconds of reading are then necessary to obtain a correct image when the photodiode is biased again.

Now, the pattern recognition process has to be executed fast, in particular within less than two hundred milliseconds, an empirically-established delay beyond which the user has a feeling of waiting.

The invention thus aims at providing a matrix detector control method, as well as a matrix detector, having a decreased electric power consumption, while being compatible with the fingerprint recognition function rapidity requirements.

### SUMMARY

An object of the invention thus is a matrix detector control method, the detector comprising a touch surface, a matrix of imaging pixels arranged in rows and in columns, an illuminating surface, each pixel comprising a transistor and a photodiode, where the pixels of at least one row may be activated or deactivated by an addressing device, the pixels of a same column being connected to a charge integrator capable of being powered on to read the content of a pixel when the latter is activated by the addressing device, the method comprising the following steps:

as long as a contact has not been detected by the touch surface, controlling the detector in a mode called standby, the standby mode periodically comprising an activation of all the pixels of the matrix detector during a first period of duration T1 by the addressing device, and a deactivation by the addressing device of all the pixels during a second period of duration T2;

on detection of the contact by the touch surface, controlling the detector in a mode called normal, the normal mode comprising the sequential activation of the pixels row by row, and the reading of the pixel activated in each column by the corresponding charge integrator, by lighting the illuminating surface.

Advantageously, ratio T1/(T1+T2) is in the range from 0.01% to 1%, and preferably equal to 0.1%.

Advantageously, the standby mode comprises, simultaneously and during the first period, the activation of all the pixels of the detector, the biasing of all the columns by the charge integrators, and the biasing of all the photodiodes of the matrix detector by the biasing system, and during the second period, simultaneously, the deactivation of all the pixels of the detector, the powering off of all the charge integrators, and the lack of biasing of all the photodiodes of the detector by biasing system SP.

Advantageously, the duration of the second period is determined so that, during this period, the voltage across each photodiode is not greater than a threshold voltage.

Advantageously, the normal mode comprises, immediately after the detection of the predetermined event, a step of activation of all the pixels of the matrix detector during the first period, followed by a step of calibration of the matrix detector comprising the reading of the pixels with the illuminating surface off, and then a reading of the pixels with the illuminating surface lit.

The invention also relates to a matrix detector comprising a matrix of imaging pixels arranged in rows and in columns, an illuminating surface, each pixel comprising a transistor and a photodiode, an addressing device configured to activate or deactivate the pixels of at least one row, a plurality of charge integrators configured to read the content of a pixel when the latter is activated by the addressing device, a biasing system connected to the pixel columns via a bus and configured to bias each of the photodiodes in reverse, the biasing system comprising a voltage source, the biasing system being configured so that the voltage source biases the photodiodes in reverse during a first period, and that the bus may then be in high impedance during a second period.

Advantageously, the biasing system comprises a switching device arranged between the voltage source and the bus.

Advantageously, the voltage source comprises a device for switching off the power supply of the voltage source, and the biasing system comprises no pull-down resistor.

Advantageously at least one capacitor is arranged between the bus and a ground.

The invention also relates to a biometric pattern recognition system, comprising a previously-mentioned detector.

### BRIEF DESCRIPTION OF THE DRAWING

Other features, details, and advantages of the invention will appear from the reading of the description made in reference with the accompanying drawings given as an example and which show, respectively:

FIG. 1, an illustration of a matrix detector according to the state of the art;

FIGS. 2A and 2B show two distinct arrangements of a matrix detector according to the invention;

FIG. 3, a timing diagram illustrating the standby mode and the normal mode in the control method according to the invention;

FIG. 4, an illustration, during the standby mode, of the signals of the addressing device (VDA), of the charge integrators (VIC), as well as of the voltage on the bus (VBU) arranged between the voltage source and the photodiodes;

FIG. 5 an illustration of the biasing system according to the invention.

### DETAILED DESCRIPTION

The invention first relates to a matrix detector control method. The structure of the pixel matrix corresponds to that of the state of the art, the operation of which has been previously described.

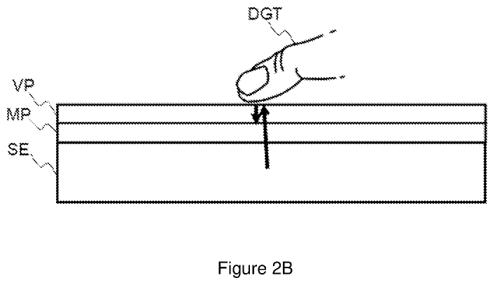

FIG. 2A illustrates a first configuration of the matrix detector according to the invention. The matrix detector comprises a pixel matrix MP, arranged under a semi-transparent illuminating surface SE, comprising OLEDs (organic light-emitting diodes). The light is emitted through illuminating surface SE, towards the object DGT for which an acquisition is to be performed (for example, a user's finger). The object DGT in contact with the detector reflects light, towards pixel matrix MP. A protecting glass VP may be provided on illuminating surface SE.

FIG. 2B illustrates a second configuration of the matrix detector according to the invention. The matrix detector comprises a semi-transparent pixel matrix MP, arranged on an illuminating surface SE. The light is emitted through illuminating surface SE, towards the object DGT for which an acquisition is to be performed (for example, a user's finger). The object DGT in contact with the detector reflects light, towards pixel matrix MP. A protecting glass VP may be provided on the pixel matrix.

Addressing device DA enables to address the different rows of the matrix, by having a voltage greater than the gate voltage of the transistors pass on the desired row. Addressing device DA comprises shift registers, having their outputs coupled to the rows of the matrix.

The addressing device may be arranged outside of the matrix, coupled to the matrix for example by flexible sheets. Row addressing devices directly implemented in the matrix, currently called GOA (Gate driver On Matrix), which enable to gain manufacturing cost, occupied space, and enable to limit connection errors with respect to the external addressing devices, have more recently appeared.

Each pixel column is connected to a charge integrator IC. The assembly of integrators itself belongs to a readout integrated circuit, also called ROIC. Each charge integrator collects the charges accumulated on the photodiodes on the corresponding column CL. As long as a row is not activated (the transistors of the row are off), the photodiode of the pixel generates a current proportional to the power of the incident light, also called photocurrent, which corresponds in the case in point to the light reflected by the object to be identified, for example, the user's finger. When the row is activated, the charges accumulated by the photodiodes are transferred to charge integrators IC. Each charge integrator IC digitizes the quantity of charge per pixel, to then transfer the digital signal to a calculation device, not shown in the drawings. The calculation device may be a dedicated circuit, for example, of ASIC (“Application-Specific Integrated Circuit”) or FPGA (“Field-Programmable Gate Matrix”) type, or an adequately programmed processor. In this last case, the calculation device may be a central processor which also fulfils other functions.

Voltage source ST generates a DC voltage to bias photodiodes PH. The biasing comprises applying a negative voltage between the anode and the cathode of the photodiode, as previously described. The value of the bias voltage determines the quantity of charges that a photodiode can collect before saturation. The quantity of charge before saturation is a linear function of the bias voltage. For biometric pattern recognition detection applications, a bias voltage in the range from −5 to −6 volts guarantees that the pixels will not saturate.

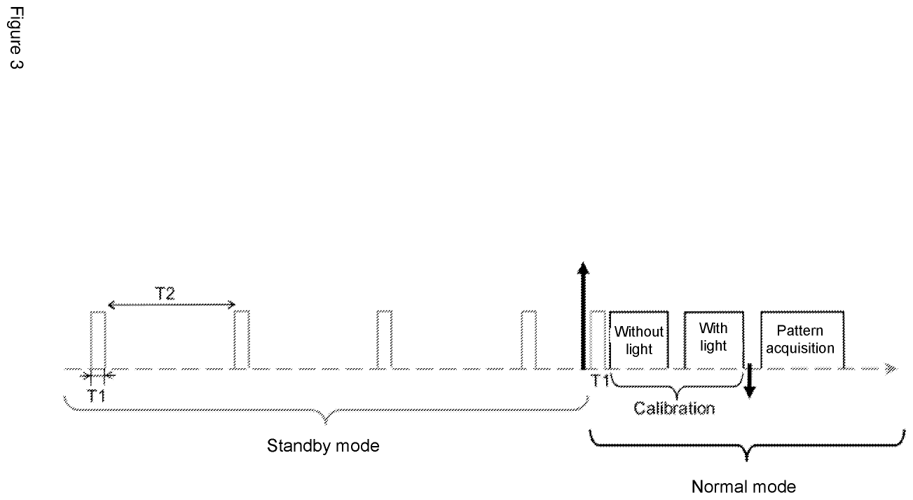

The method according to the invention relies on two distinct modes, that is, a standby mode and a normal mode, illustrated in FIG. 3. The normal mode is activated as soon as a contact has been detected. For this purpose, the detector must comprise a touch surface.

As long as a contact has not been detected by the touch surface, the standby mode is implemented. The standby mode enables to have a decreased power consumption of the different components of the matrix detector, in particular, of voltage source ST.

The standby mode periodically comprises an activation of all the pixels PI of the matrix detector during a first period by addressing device DA. The activation of all the pixels enables to leave the pixel matrix in a state ready to capture clean images. The activation of all the pixels PI is managed by the calculation device, which orders addressing device DA to turn on, at the same time, all the transistors TR of all rows LN, during a first period T1, and which orders the charge integrators to integrate the charges transmitted by each photodiode. Then, all the rows are set to a low-level voltage, which turns off all the transistors TR of all rows LN. For this purpose, the calculation device orders addressing device DA to deactivate all the pixels PI, during a second period T2 and, at the same time, to disconnect the charge integrators IC from their corresponding column.

Then, when a contact has been detected by the touch surface, the matrix detector is controlled in a mode called normal. The normal mode comprises the sequential activation of pixels PI row by row, and the reading of the pixel PI activated in each column by the corresponding charge integrator CI, by lighting the illuminating surface. The touch surface may be a capacitive surface arranged under the pixel matrix. The sequential activation of the pixels, row by row, is implemented by having the high level of a voltage pass between the different shift registers forming addressing device DA. The sequential activation of the pixels of each row, row after row, enables to scan the entire surface of the matrix detector.

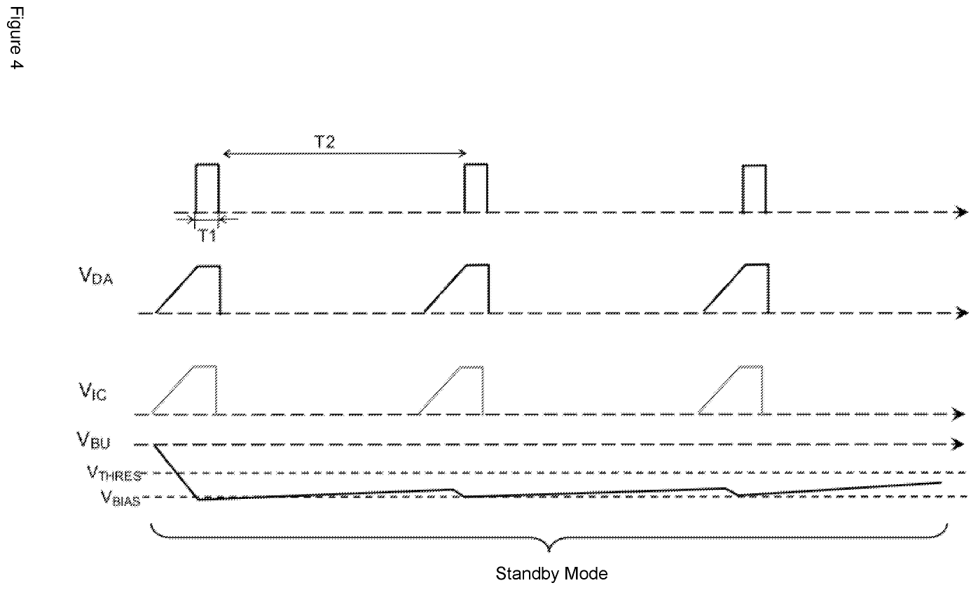

FIG. 4 illustrates in detail different timing diagrams during the standby mode. Signal VDA corresponds to the voltage, across each of the outputs of the addressing device. Signal VIC corresponds to the voltage, across each of the outputs of the addressing device. Signal VBU corresponds to the voltage on the bus BU which couples voltage source ST to columns CL. Bus BU enables to couple voltage source ST to columns CL, to bias photodiodes PH.

Photodiodes PH are advantageously permanently biased during the standby mode, to avoid the previously-described lag phenomenon. During first period T1, the photodiodes are biased with the voltage imposed by voltage source ST: the voltage VBU on bus BU decreases to reach the voltage require to correctly bias photodiodes PH in reverse, with a voltage VBIAS (in the order of −6 V for organic or amorphous silicon photodiodes). The ramps of voltage VDA and VIC are due to the different capacitive elements present in the matrix detector.

During second period T2, photodiodes PH are no longer biased by voltage source ST. However, the leakage currents of the photodiodes raise voltage VBU. The equivalent circuit of a photodiode indeed comprises a so-called junction capacitive element, which corresponds to the terminals of the depletion region. These terminals play the role of the plates of a capacitor with parallel plates. For each photodiode, there thus is a charge reservoir linked to the junction capacitive element, which causes leakage currents. For organic or amorphous silicon photodiodes, the junction capacitance typically is 0.14 pF. Further, each interconnection between the anode of a photodiode and the photodiode bias column has a stray capacitance, of a few femto farads. The junction capacitive element and the parasitic interconnection capacitive element thus take the charges which are on nodes ND and take them back to the level of each cathode of photodiodes PH.

Thus, during first period T1, voltage source ST imposes a voltage VBIAS. The electric voltage across a capacitor being proportional to its charge, by imposing voltage VBIAS during first period T1, one thus obtains, at the end of first period T1, a quantity q of charges at the level of each node ND.

During second period T2, nodes ND are set to high impedance. The quantity of charge will progressively decrease and will be stored at the level of the cathode of each photodiode PH. As illustrated by voltage VBU in FIG. 4, the voltage on the bus intended to bias the photodiode slightly rises during second period T2. Then, when voltage source ST imposes again its voltage during the next first period T1, the junction capacitive element and the parasitic capacitive element are recharged again.

The calculation device (not shown in the drawings), having voltage source ST, addressing device DA, as well as charge integrators IC, connected therewith, controls the setting to high impedance of nodes ND, during each second period T2.

Advantageously, the value of second period T2 is determined so that the voltage across each photodiode (PH) is not greater than a threshold voltage VTHRES. Threshold voltage VTHRES is such that no lag phenomenon appears as long as the photodiode is biased with a voltage smaller than or equal to threshold voltage VTHRES. Threshold voltage VTHRES may advantageously be in the range from 80% to 90% of the voltage VBIAS imposed by the voltage source. For example, for a voltage VBIAS equal to −6 V, it is possible to let voltage VBU rise up to −5 V, without for this to create a lag phenomenon at the level of the pixels.

The duty cycle between first period T1 and second period T2 should further be determined to decrease as much as possible the power consumption of the matrix detector in the standby mode, while giving time to the junction capacitive elements and to the parasitic capacitive elements to optimally recharge, during each first period T1. Further, first period T1 should give time to the pixel matrix to be reset to zero, by activating all the pixels PI of the detector, by biasing all the columns with charge integrators IC, and by biasing all the photodiodes PH of the matrix detector.

A ratio T1/(T1+T2) between 0.01% and 1%, and preferably equal to 0.1%, is advantageously set, which enables to strongly decrease the power consumption of the detector while leaving the pixel matrix in a sufficiently “clean” state to have a correct image from as soon as the waking up of the system.

During the detection, by the touch surface, of a predetermined event, the standby mode stops, and is replaced with a normal mode. The predetermined event may for example be the detection of a contact such as a fingerprint, the detection of a venous system pattern, or also the detection of a document to be scanned. In FIG. 3, the predetermined event corresponds to the upward arrow.

The pattern acquisition may be performed as soon as a contact has been detected, but this embodiment is not optimal. Indeed, it may be advantageous, from as soon as the beginning of the normal mode, to activate all the pixels of the matrix detector during first period T1, to bias all photodiodes PH, and to also bias all charge integrators IC to evacuate the charges accumulated in photodiodes PH. This step is particularly advantageous if the predetermined even occurs long after the last time when there has been a simultaneous activation of all the pixels of the matrix, in the standby mode. A delay of approximately one millisecond may be sufficient to activate all the pixels, which does not lengthen the authentication procedure, from the point of view of the user, given that the user has a feeling of waiting for a waiting delay greater than two hundred milliseconds.

Advantageously, the pattern acquisition step may also be preceded by a step of calibration of the matrix detector, comprising the reading of pixels PI with the illuminating surface off, and then a reading of pixels PI with the illuminating surface lit. The calibration step may occur after the first period T1 during which all the pixels have been activated, as a consequence of the detection of the predetermined event.

The reading of the pixels with the illuminating surface off, and then the reading of the pixels with the illuminating surface lit enables to determine an offset reference for each pixel.

As a consequence of the calibration step, the biometric patterns can be acquired (or the document can be scanned), which is shown by the downward arrow in FIG. 3. There may be a plurality of repetitions of the reading from the matrix detector, to correlate the acquired images, from one capture to the other.

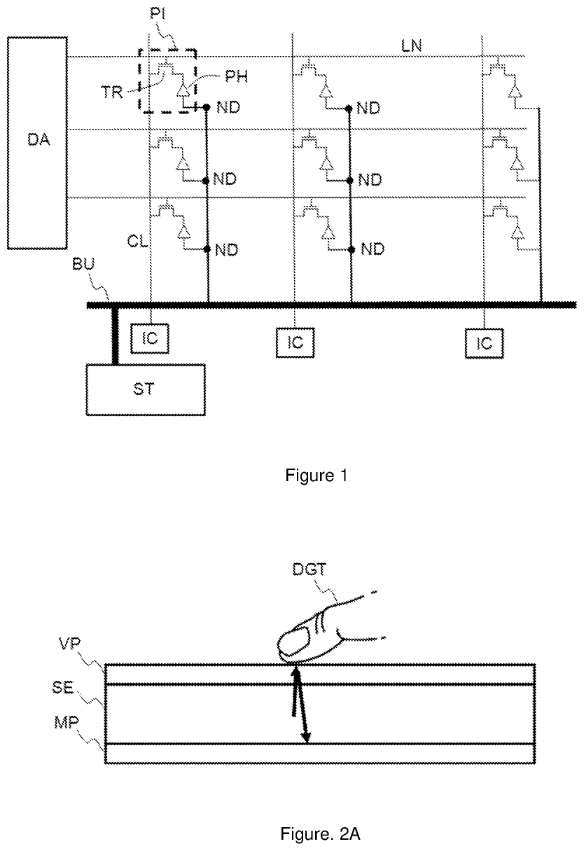

The invention also relates to a matrix detector. The matrix detector comprises a plurality of pixels arranged in rows and in columns, an addressing device DA, as well as an assembly of charge integrators IC, as illustrated in FIG. 1.

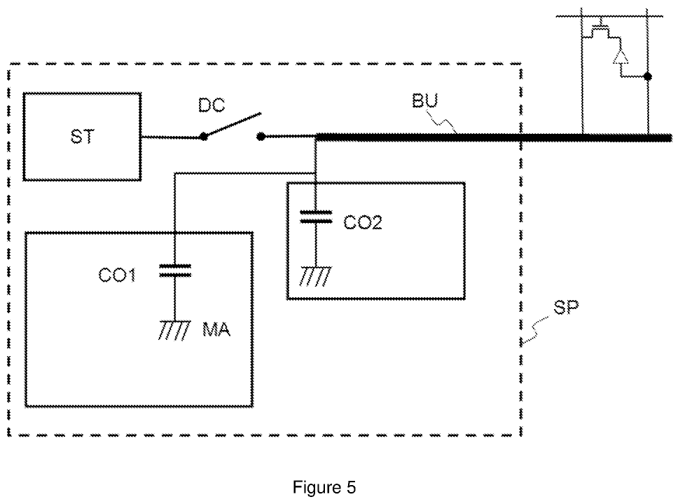

FIG. 5 illustrates in detail the biasing system SP of the detector comprised in the matrix detector according to the invention. Biasing system SP is configured to set nodes ND to high impedance, during the standby mode. The portion of the pixel matrix illustrated in FIG. 5 corresponds to a pixel matrix according to the state of the art, such as illustrated for example by FIG. 1.

Biasing system SP comprises voltage source ST. Voltage source ST is capable of imposing a reverse bias voltage to the photodiodes PH of each column, via bus BU.

During first period T1, the voltage source biases the photodiodes in reverse. During second period T2, bus BU is in high impedance. Due to the junction capacitance of each of the photodiodes, and to the parasitic capacitance created by the interconnection between the anode of each photodiode and the corresponding bias column, the fact of being in high impedance enables to charges located in these capacitances to pass into the cathode of each photodiode, and thus to maintain their bias state, at a voltage smaller than or equal to threshold voltage VTHRES.

The setting to high impedance of buses BU may be performed in two ways.

According to a first embodiment, a switching device DC is arranged between voltage source ST and bus BU. Switching device DC may for example be a controlled switch. In particular, the controlled switch may be a TFT transistor, to be printed with the pixel matrix. Thus, during each first period T1, switch device DC is on/closed, and during each second period T2, switching device DC is off/open. This embodiment enables to rapidly set the bus to high impedance, that is, the time necessary for switching device DC to switch from on/closed to off/open.

According to a second embodiment (not shown in FIG. 5), the power supply of voltage source ST is switched off during each second period T2, by means of a power supply switch-off device. This embodiment enables to gain electric power consumption, as compared with the first embodiment, since voltage source ST has a zero power consumption during second period T2. It should however be ascertained that biasing system SP comprises no pull-down resistor, to avoid for voltage source ST to be set to ground when it is not powered. Indeed, the grounding would prevent bus BU from being in high impedance.

Advantageously, at least one capacitor (CO1, CO2) is arranged between bus BU and ground MA, as illustrated in FIG. 5. The fact of inserting one or a plurality of capacitors enables to set the slope of voltage VBU to the standby mode, by making the slope more or less steep. Thus, if the slope is less steep, it is then possible to space apart the periods of activation of all the pixels (periods T1) , which enables to gain electric power consumption. However, the higher the capacitance of the capacitor (CO1, CO2), the more time it will take to charge. The determination of the capacitance of the capacitor (CO1, CO2) thus has to take these constraints into account.

The capacitor may be a capacitor CO1 arranged on the electronic board on which is located the calculation device, between bus BU and ground MA. Thus, it is possible to use a capacitor having a high capacitance, provided for it to be compatible with the constraints of implantation on the board. As a variant, the capacitor may be arranged around the pixel matrix, for example, on the flexible printed substrate, to avoid congesting the electronic board.

1. A matrix detector control method, the detector comprising a touch surface, a matrix of imaging pixels arranged in rows and in columns, an illuminating surface, each pixel comprising a transistor and a photodiode, where the pixels of at least one row may be activated or deactivated by an addressing device, the pixels of a same column being connected to a charge integrator capable of being powered on to read the content of a pixel when the latter is activated by the addressing device, the method comprising the steps of:
as long as a contact has not been detected by the touch surface, controlling the detector in a mode called standby, the standby mode periodically comprising an activation of all the pixels of the matrix detector during a first period of duration T1 by the addressing device, a reverse biasing of the photodiodes, and a deactivation by the addressing device of all the pixels during a second period of duration T2;
on detection of the contact by the touch surface, controlling the detector in a mode called normal, the normal mode comprising the sequential activation of the pixels row by row, and the reading of the pixel activated in each column by the corresponding charge integrator, by lighting the illuminating surface.

2. The method according to claim 1, wherein ratio T1/(T1+T2) is in the range from 0.01% to 1% or equal to 0.1%.

3. The method according to claim 1, wherein the standby mode comprises, simultaneously and during the first period, the activation of all the pixels of the detector, the biasing of all the columns by the charge integrators, and the biasing of all the photodiodes of the matrix detector by the biasing system, and during the second period, simultaneously, the deactivation of all the pixels of the detector, the powering off of all the charge integrators, and the lack of biasing of all the photodiodes of the detector by the biasing system.

4. The method according to claim 1, wherein the duration of the second period is determined so that, during this period, the voltage across each photodiode is not greater than a threshold voltage.

5. The method according to claim 4, wherein the threshold voltage is determined so that no lag phenomenon appears as long as each photodiode is biased with a voltage smaller than or equal to threshold voltage.

6. The method according to claim 4, wherein threshold voltage is in the range from 80% to 90% of a bias voltage of the photodiodes.

7. The method according to claim 1, wherein the normal mode comprises, immediately after the detection of the predetermined event, a step of activation of all the pixels of the matrix detector during the first period, followed by a step of calibration of the matrix detector comprising the reading of the pixels with the illuminating surface off, and then a reading of the pixels with the illuminating surface lit.

8. A matrix detector comprising a touch surface, a matrix of imaging pixels arranged in rows and in columns, an illuminating surface, each pixel comprising a transistor and a photodiode, an addressing device configured to activate or deactivate the pixels of at least one row, a plurality of charge integrators configured to read the content of a pixel when the latter is activated by the addressing device (DA),
the matrix detector being configured to be controlled in a mode called standby as long as a contact has not been detected by the touch surface, the standby mode periodically comprising an activation of all the pixels of the matrix detector during a first period of duration by the addressing device, and a deactivation by the addressing device of all the pixels during a second period of duration,
the matrix detector being further configured to be controlled in a mode called normal, the normal mode comprising the sequential activation of the pixels row by row, and the reading of the pixel activated in each column by the corresponding charge integrator, by lighting the illuminating surface,
a biasing system connected to the pixel columns via a bus and configured to bias each of the photodiodes in reverse, the biasing system comprising a voltage source, the biasing system being configured so that the voltage source biases the photodiodes in reverse during the first period, and that the bus may then be in high impedance during the second period.

9. The matrix detector according to claim 8, wherein the biasing system comprises a switching device arranged between the voltage source and the bus.

10. The matrix detector according to claim 8, wherein the voltage source comprises a device for switching off the power supply of the voltage source, the biasing system comprising no pull-down resistor.

11. The matrix detector according to claim 8, wherein at least one capacitor is arranged between the bus and a ground.

12. A biometric pattern recognition system, comprising a detector according to claim 8.
